(19) United States
(12) Patent Application Publication
(10) Pub. No.: US 2015/0274002 A1
(43) Pub. Date: Oct. 1, 2015

(54) VENTILATION SHUTTER FOR A MOTOR VEHICLE WITH A LOW AERAULIC SIGNATURE

(71) Applicant: VALEO SYSTEMES THERMIQUES, Le Mesnil Saint-Denis (FR)

(72) Inventors: Frédéric Vacca, Behoust (FR); Jean-Louis Lanard, Feucherolles (FR)

(73) Assignee: VALEO SYSTEMES THERMIQUES, Le Mesnil Saint Denis (FR)

(21) Appl. No.: 14/438,012

(22) PCT Filed: Oct. 22, 2013
(86) PCT No.: PCT/EP2013/072032

§ 371 Date: Apr. 23, 2015

(30) Foreign Application Priority Data
Oct. 25, 2012 (FR) 1260190

(51) Int. Cl. B60K 11/08; B29C 45/17; B60H 1/00

(52) U.S. Cl. CPC B60K 11/085; B60H 1/00678; B29C 45/1704; B60H 2001/007; B60H 2001/00721; B29L 2031/3032

(57) ABSTRACT

A shutter for a ventilation duct for a motor vehicle is disclosed. The shutter extends longitudinally along an axis of rotation, and includes an upstream part and a downstream part which are connected by a rib at which the axis of rotation is located. The upstream and downstream parts have ends situated on both sides of a plane P which passes via said axis of rotation, such as to allow one of the ends of the shutter to be overlapped by the other end of a similar shutter disposed in an adjacent manner. A longitudinal cavity extends along the axis of rotation and passes through the upstream and/or the downstream part. The upstream and/or downstream part(s) are provided with a cavity situated in the projecting front surface of the rib and of the end of the other part.

The field of the present invention is that of motor vehicles, and more particularly that of devices for cooling of equipment of the motor vehicle.

Vehicles with a thermal engine need to discharge the calories generated by their running, and for this purpose they are equipped with heat exchangers, in particular cooling radiators, which are placed at the front of the vehicle, and through which air from the exterior passes. In order to force the circulation of this air through the exchanger(s), a fan is placed upstream or downstream from the latter, upstream or downstream in this document being taken into consideration with reference to the direction of the flow of air.

The intakes for the cooling air are placed at the front of the motor vehicle, at its front surface, and radiator grilles are conventionally placed through them in order to permit the circulation of the air to the exchanger(s), whilst limiting the intake of foreign bodies.

Generally there are two air intakes, one for a so-called high route, placed above the fender of the vehicle, and one for a so-called low route, which collects air below this same fender. The heat exchangers, such as condensers or radiators are for their part placed downstream from the beam which supports the fender, and are supplied by the two, high and low routes.

It is known to use controlled shutters on the front surface in order to reduce the drag coefficient, and also to improve the functioning of the cooling and air conditioning. These shutters, which can be disposed on the low route behind the radiator grilles, are disposed horizontally or vertically through the flow, and can be either open, and allow the maximum amount of air to pass, or they can be more or less closed, and then shut this low route partially or entirely.

In order to increase the rigidity of the shutters, they are commonly produced in the form of two coplanar longilinear plates which extend along their axis of rotation, and are separated by a rib which extends perpendicularly to their plane. A rib of this type makes it possible to strengthen the shutter, but it constitutes a source of increase of the aeraulic signature of the shutters in the open position.

In addition, the shutters have ends which are situated on both sides of a plane which passes via said axis of rotation, such as to allow one of the ends of said shutter to be overlapped by the other end of a similar shutter disposed in an adjacent manner, in the closed position of the shutters. This therefore provides good sealing, in particular by plane-on-plane contact. However, such ends constitute another source of increase of the aeraulic signature of the shutters in the open position.

In this position, the shutters thus constitute an obstacle which, by means of its front surface, opposes the circulation of the air, which is detrimental to the performance of the cooling system of the vehicle. The larger this surface, the greater the aeraulic load loss caused by this obstacle, and it is therefore important to reduce as far as possible its impact on the circulation of the air. One of the solutions which could be envisaged would be to reduce the thicknesses of material, but this modification would give rise to reduction of the rigidity of the shutters, which is incompatible with good resistance to the phenomenon of floating of the shutters in the flow of air.

The objective of the present invention is to propose a shutter which retains the aforementioned advantages of rigidity and sealing, whilst eliminating the above-described disadvantages, in particular by providing a low aeraulic signature.

For this purpose, the invention relates to a shutter for a ventilation duct, in particular for a motor vehicle, which extends longitudinally along an axis of rotation, and comprises an upstream part and a downstream part which are connected by a rib at which said axis of rotation is located, said upstream and downstream parts having ends situated on both sides of a plane P which passes via said axis of rotation, such as to allow one of the ends of said shutter to be overlapped by the other end of a similar adjacent said shutter.

According to the invention, through said upstream and/or said downstream part, there passes a longitudinal cavity, which extends in particular in parallel, along said axis of rotation, said upstream and/or downstream part(s) provided with said cavity being situated in the projecting front surface of said rib and of the end of the other part. It will be appreciated that projecting front surface means the surface occupied by the projection of the part(s) of the shutter in question, according to a direction of projection defined by the direction P at right-angles to said axis of rotation, on a plane at right-angles to said direction of projection.

By maintaining said ends, the sealing provided by the prior shutters is retained. Maintaining said rib contributes to ensuring satisfactory rigidity. In addition, providing a cavity in a part of the shutter situated in the aeraulic signature which the shutter also has because of said ends and said rib, provides a solution which makes it possible to reduce the thickness of the shutter and thus its aeraulic signature, without detracting from its rigidity. A reduction in the weight of the shutter is also obtained.

According to different embodiments which can be taken together or separately:
said upstream and/or downstream part(s) provided with said cavity comprise a first and second wall which are located on both sides of said corresponding cavity;
said cavity is substantially centered between said first and second walls;
said second wall and said end of said upstream and/or downstream part provided with said cavity form a second rib with orientation opposite that of the rib at which said axis of rotation of the shutter is located, referred to as first rib, and said first wall permits staying of said second rib on said first rib;
the end of said upstream and/or downstream part(s) provided with said cavity is situated substantially at said corresponding cavity, in the direction at right-angles to the plane P;
the rib comprises a groove at which said axis of rotation is provided;
said groove forms a widened “U”, with the branches of the “U” being spaced from one another, as they approach said upstream and downstream parts.

It should be noted that this last characteristic makes it possible to decrease the weight of the shutter without detriment to its rigidity, and without it necessarily being provided with the aforementioned cavity. The invention also relates to a shutter for a ventilation duct, in particular for a motor vehicle, which extends longitudinally along an axis of rotation, and comprises an upstream part and a downstream part connected by a rib at which said axis of rotation is located, said rib comprising a groove at which said axis of rotation is provided, said groove forming a widened “U”, the branches of the “U” being spaced from one another as they approach said upstream and downstream parts. It can also be noted that the widening of the “U” of the rib additionally allows its top to be lowered, and thus permits a decrease in its aeraulic signature.

This being the case, the first wall can comprise a flat surface, parallel to said plane P, which is connected to a top of said rib, and/or the second wall can comprise a flat surface, parallel to said plane P, which is connected to a base of said rib 5. This configuration makes possible a greater depth for the cavity, which improves the rigidity of the shutter, without affecting its aerodynamics, since, as previously stated, the part which is provided with the cavity remains within the aeraulic signature of said rib and/or of the end of the part opposite the shutter. The deflections of the air by the surface of the shutter, in particular by said rib, are simply advanced in the direction of its leading edge, or drawn back to its trailing edge in the case of a cavity which is placed inside the downstream part.

On this subject, said cavity is advantageously situated at only one of said parts, in particular the upstream part. The end of the part provided with said cavity is situated for example in the projecting front surface of said rib.

The invention also relates to a method for production by injection of a shutter as previously described, characterized in that it comprises injection of a pressurized fluid into the middle of the thickness of at least one of the parts of said shutter.

It also relates to a ventilation duct for a motor vehicle, comprising an outer channel and a series of shutters, each being mobile in rotation around an axis, positioned in cascade parallel to and adjacent to one another, characterized in that it comprises at least one shutter as previously described.

Finally, the invention relates to a motor vehicle comprising a ventilation duct of this type, positioned upstream or downstream from a heat exchanger.

The invention will be better understood, and other objectives, details, characteristics and advantages thereof will become more apparent from the following detailed explanatory description of an embodiment of the invention, provided purely by way of illustrative non-limiting example, with reference to the accompanying schematic drawings.

In these drawings:

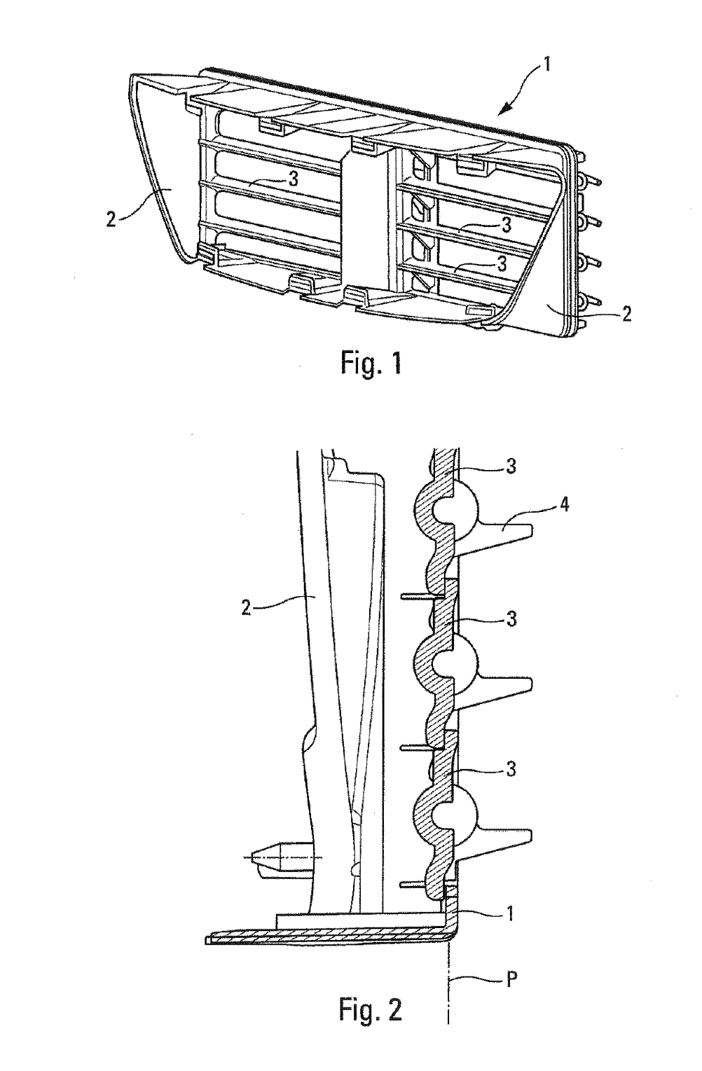

FIG. 1 is a view in perspective of a duct for the intake of ventilation air on the front surface of a motor vehicle;;

FIG. 2 is a view in cross-section of a device for shutting the duct in FIG. 1 by shutters, the latter being in the closed position;

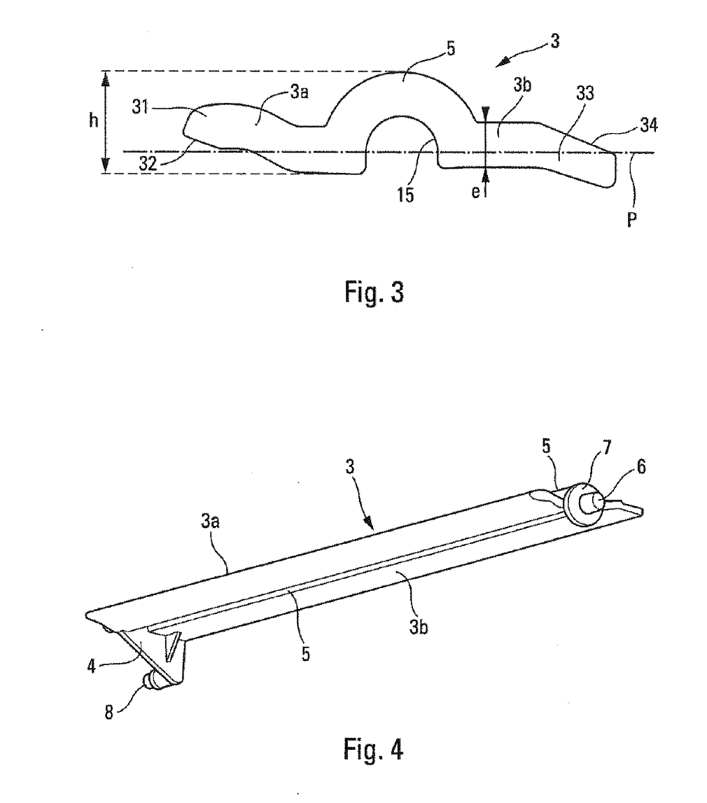

FIG. 3 is a view in transverse cross-section of a shutter for the duct in FIG. 1 according to the prior art;

FIG. 4 is a view in perspective from below of the shutter in FIG. 3;

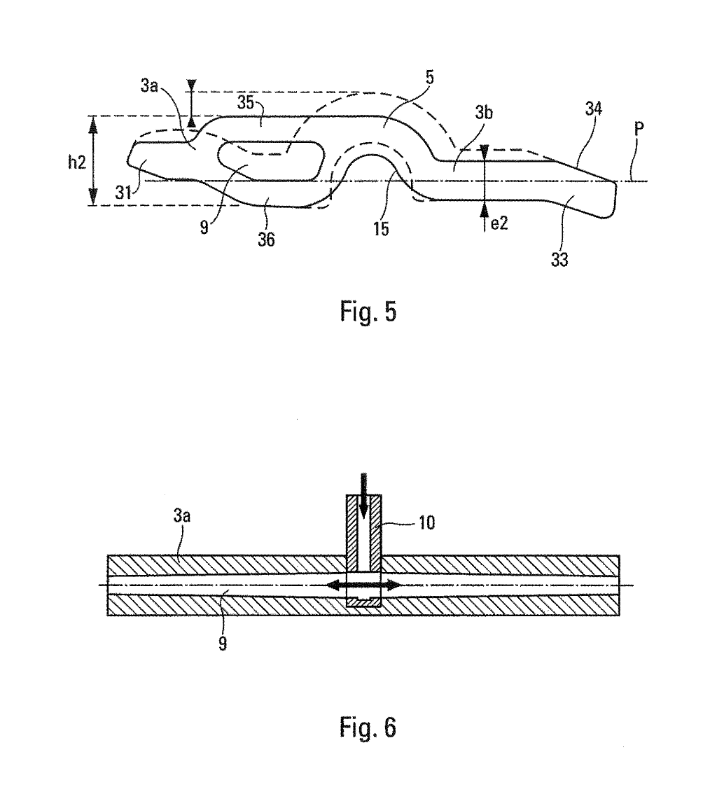

FIG. 5 is a view in cross-section of a shutter for the duct in FIG. 1, in an embodiment of the invention; and

FIG. 6 is a view in cross-section from above of the shutter in FIG. 5 during its production.

FIG. 1 shows a duct 1 for guiding of the air which penetrates into the front enclosure of a motor vehicle, and is oriented in the direction of a heat exchanger such as a condenser or a radiator, not represented. This duct comprises an outer channel 2 with a substantially parallelepiped form, which is joined upstream to a radiator grille, also not represented, designed to prevent any penetration by foreign bodies, whilst constituting a style element. Downstream, it supports a series of shutters 3 which are positioned in cascade one above another, and are mobile in rotation, each around a horizontal axis. The shutters are disposed one above another such that, in the closed position, they are contiguous, and block the air stream completely.

FIG. 2 shows in cross-section, on a vertical plane which is oriented in the direction of circulation of the ventilation air, three shutters 3 which are positioned one above another, and are supported by the structure of the guide duct 1. In this case, three shutters are represented, but there is a sufficient number of them to cover all of the outlet surface of the duct in the closed position, such as to be able to shut this surface, and therefore block the passage of the air to this air intake. At one of their ends, the shutters, the form of which will be described in greater detail with reference to FIGS. 3 and 4, comprise a radial extension which acts as a lever arm 4 in order to activate them in rotation. It will be noted that these shutters have at their upstream and downstream ends (with reference to the direction of circulation of the air when they are in the open position) surfaces which cooperate with one another, such as to ensure inter-shutter sealing, and prevent passage of the air between two consecutive shutters. As represented, these co-operating surfaces are in this case flat surfaces with the same orientation, which allows them to be contiguous. They are situated on both sides of a plane P, in this case a vertical plane, which passes via said axis of rotation.

FIGS. 3 and 4 show a shutter 3, respectively in transverse cross-section and in perspective. The shutter itself, i.e. the part which guides or obstructs the flow of air, is in the form of a plate with a constant thickness e, comprising an upstream part 3a and a downstream part 3b which are separated by a rib 5 in the form of an inverted “U”. The two, upstream and downstream parts extend longitudinally along the direction of the axis of rotation of the shutter, and transversely in the same radial plane relative to this axis of rotation, however with undulations relative to this plane which tend to reduce their aerodynamic impact. The rib 5, for its part, extends perpendicularly to the plane of the two, upstream 3a and downstream 3b parts, and hereinafter in the description, “upper” or “lower” will refer to the direction of extension of this rib. In the surface opposite the rib there is a groove 15 with the same form, which fits into the rib 5, such that the same thickness e of the shutter is maintained at this rib, and thus the mass of the shutter is not increased unnecessarily.

The function of this rib is to provide the shutter with longitudinal rigidity in order to prevent vibratory phenomena, or floating, liable to be created by the excitation associated with the passage of the air. The upstream end 31 of the upstream part 3a is rounded in order to form a leading edge for the shutter and reduce its aerodynamic drag, and on its lower part it has a flat surface 32 which forms a given angle with the median plane of the shutter; similarly, the downstream end 33 of the downstream part 3b is in the form of a cap, also in order to reduce the drag, and on its upper part it has a flat surface 34, which is oriented at the same angle as the flat upstream surface 32. Thus, when two adjacent shutters are folded back against one another, the flat upstream surface 32 of the upper shutter is placed against the flat downstream surface 34 of the lower shutter, with which it is perfectly contiguous, thus ensuring sealing against possible circulation of air between these two shutters.

At its two longitudinal ends, the shutter 3 comprises means in order to rotate it around an axis which extends substantially along the center of the circle which forms the base of the “U” of its rib 5. These means consist of two journals 6 which extend longitudinally at each of its ends, along this axis, beyond the shutter itself. Disks 7 which extend radially around these journals form a sealing barrier with the channel 2 of the duct 1. At one of its ends, there is also an activating device for rotation of the shutter. This device is in the form of a radial plate 4, which, spaced from the axis of rotation, supports a second journal 8 on which there can be secured a control rod (not represented) which, by means of longitudinal displacement, creates rotation of the plate 4, and thus rotation of the shutter 3 assembly. It is found that the aeraulic signature of the shutter in the open position corresponds in one direction to the vertical extension of the rib 5, and in the other direction it corresponds to the vertical extension of the downstream end 33.

FIG. 5 shows as a solid line the shutter 3 which constitutes the configuration proposed by the invention, with the shutter 3 according to the prior art being illustrated in broken lines in order to facilitate the comparison. The invention is characterized by a decrease in the thickness of the walls which form the shutter 3. The layers of material which form both the upstream part 3a and the downstream part 3b have a thickness e2 which is smaller than the thickness e which these layers had in the prior art. By way of reference, whereas the walls in the prior art had a thickness of 4 mm, in this case the invention proposes to reduce this thickness to 3 mm.

Since this decrease in thickness is liable to generate phenomena of aerodynamic floating, this phenomenon needs to be compensated for by increasing the rigidity of the upstream and/or downstream parts. For this purpose, the upstream part 3a in FIG. 5 has a closed cavity 9. This cavity extends transversely along the direction of extension of the upstream part 3a, in which it is contained entirely. Said cavity is in this case delimited by walls comprising walls which extend along the direction of intake of the flow of air, and are separated by said cavity 9.

The upstream tip 31 of the upstream part 3a is identical to those according to the prior art, i.e. it has a rounded edge which forms the leading edge of the shutter, and a flat upstream surface 32 on its lower part, which forms the same angle as previously with the median plane of the shutter. In turn the upstream part, as represented in FIG. 6, is not modified in comparison with the previous version, apart from its thickness; in particular it has the same flat downstream surface 34 which is able to cooperate with the upstream surface 32 of an adjacent shutter.

Downstream from the front tip 31, the upstream part 3a is divided into two walls 35, 36, i.e. a first wall 35 which in this case is the upper wall and a second wall 36 which in this case is the lower wall, the thicknesses of which can be smaller than the thickness e2 of the other walls, which are not split. The upper layer 35 is for example flat, oriented in the direction of intake of the flow of air, and is connected to the top of the rib 5 without any projection. The projection which existed in the prior art between the front tip 31 and the rib 5 has thereby been displaced from the upstream surface of the rib 5 to the upstream part of the upper layer 35. This therefore provides a cavity, the size of which is optimized, whilst assisting the flow of air on the upper surface of the shutter 3, and limiting the associated drag coefficient.

As far as the lower wall 36 is concerned, its lower surface can once again have the form of the lower surface of the shutter 3 according to the prior art, i.e. it continues to be aligned slightly below the lower surface of the downstream part 3b, and can go as far as being aligned with the latter in a particular embodiment. It therefore leaves this lower surface of the downstream part in its wake, in order to avoid increasing the projecting front surface of the shutter. It can be considered that the upper wall 35 permits staying of the lower wall 36 and/or of the end 31 of the corresponding upstream part on the rib 5.

Said upper 35 and lower 36 walls are for example parallel.

At the projecting front surface of the shutter, the lower surface of the latter (which acts as a basis for comparison with the prior art) benefits from the thinning (e−e2) of the walls which are not split, whereas the upper surface benefits from the lowering of the top of the rib, derived from this same thinning. In the end, the height h2 of the shutter according to the invention is lower than the height h according to the prior art. The difference in height obtained is therefore derived from the thinning (e−e2) of the walls of this same rib.

The shutter according to the invention can also have widening of the walls of the “U” of the rib 5, which are no longer parallel to one another, and are spaced from one another as they approach the plane of the two parts 3a, 3b of the shutter. This modification also contributes towards lowering the top of the rib 5 of the shutter, with a constant thickness. The aerodynamics of the lower surface of the shutter 3 are also improved in comparison with the prior art, with a reduced drag coefficient Cx and an associated reduction in the drag force.

FIG. 6 shows a basic diagram describing the production process which makes it possible to obtain the cavity 9 provided in the upstream part 3a of the shutter. It shows the injection of a fluid into the thickness of the shutter during its production, which makes it possible to limit the general deformation of the shutter, but also a possible defect in the form of the cavity. For this purpose, a needle 10 with a double outlet is positioned in the recess in the part, in its middle. Then, during the injection of the plastic material, for example a PAFG30, which constitutes the shutter, a fluid is injected under pressure into the middle of the thickness of the shutter. This results in thrusting of the material, leaving behind it a cavity which is thrust back to the ends of the part; the protuberance thus created is then cut after the injection, in order to provide the two ends of the shutter with the required form.

By this means, the deformation of the cavity which is caused by the difference in pressure between a position close to the needle and a position close to the ends of the shutter, remains low. It thus gives rise to a lesser geometrical defect than if the injection needle were for example situated at the end of the shutter.

The figures are represented with a cavity 9 placed in the upstream part 3a of the shutter 3. It will be appreciated that a cavity of this type can be placed in the downstream part 3b, or each of the two parts 3a and 3b can be provided with a cavity of this type.

By way of reference, the shutters described in the figures have thicknesses of 4 mm in the version according to the prior art, whereas in the invention this thickness has been reduced to 3 mm apart from in the split parts, without thereby detracting from the rigidity of the shutter. At the projecting front surfaces, the heights measured go from 9 mm in the prior art to 6.5 mm in the invention. Taking into account a length of the shutters which is maintained as 292 mm in all three cases, the projecting surfaces thus go from 2628 mm² to 1898 mm², i.e. a reduction of 28% in the invention in comparison with the prior art, without detracting from the rigidity of the shutter. In parallel, the saving in weight obtained with the invention is 26 g per shutter, derived substantially from the reduction in the thickness of its walls.

1. A shutter for a ventilation duct for a motor vehicle, the shutter extending longitudinally along an axis of rotation and comprising:
an upstream part and a downstream part which are connected by a first rib at which said axis of rotation is located, said upstream and downstream parts having ends situated on both sides of a plane which passes via said axis of rotation, such as to allow one end of said shutter to be overlapped by another end of a similar shutter disposed in an adjacent manner; and
a longitudinal cavity, which extends along said axis of rotation, passing through the upstream and/or the downstream part, said upstream and/or downstream part(s) provided with said cavity being situated in the projecting front surface of said first rib and of the end of the other of the upstream and/or downstream part.

2. The shutter as claimed in claim 1, wherein said upstream and/or downstream part(s) provided with said cavity comprise a first and a second wall which are located on both sides of said corresponding cavity.

3. The shutter as claimed in claim 2, wherein said cavity is substantially centered between said first and second walls.

4. The shutter as claimed in claim 2, wherein the first wall comprises a flat surface, parallel to said plane, which is connected to a top of said first rib.

5. The shutter as claimed in claim 2, wherein the second wall comprises a flat surface, parallel to said plane, which is connected to a base of said first rib.

6. The shutter as claimed in claim 2, wherein said second wall and said end of said upstream and/or downstream part provided with said cavity form a second rib with an orientation opposite that of the first rib at which said axis of rotation of the shutter is located and said first wall permits staying of said second rib on said first rib.

7. The shutter as claimed in claim 2, wherein the end of said upstream and/or downstream part(s) provided with said cavity is situated substantially at said corresponding cavity, along the direction at right-angles to said plane.

8. The shutter as claimed in claim 1, wherein the first rib comprises a groove at which said axis of rotation is provided.

9. The shutter as claimed in claim 8, wherein said groove forms a widened “U”, with the branches of the “U” being spaced from one another as they approach said upstream and downstream parts.

10. The shutter as claimed in claim 1, wherein said cavity is situated at only one of said upstream and downstream parts.

11. The shutter as claimed in claim 10, wherein said part provided with said cavity is the upstream part.

12. The shutter as claimed in claim 11, wherein the end of said upstream part provided with said cavity is situated in the projecting front surface of said rib.

13. A method for production by injection of a shutter as claimed in claim 1, the method comprising injection of a pressurized fluid into the middle of the thickness of at least one of the upstream or downstream parts of said shutter.

14. A ventilation duct for a motor vehicle, comprising:
an outer channel and a series of shutters, each being mobile in rotation around an axis, positioned in cascade parallel to and adjacent to one another; and
at least one shutter as claimed in claim 1.
